(19) United States
(12) Patent Application Publication
(10) Pub. No.: US 2025/0028454 A1
(43) Pub. Date: Jan. 23, 2025

(54) STORAGE SYSTEM AND BACKUP METHOD FOR STORAGE SYSTEM

(71) Applicant: Hitachi, Ltd., Tokyo (JP)

(72) Inventors: Masanori TAKATA, Tokyo (JP); Mitsuo HAYASAKA, Tokyo (JP)

(21) Appl. No.: 18/586,637

(22) Filed: Feb. 26, 2024

(30) Foreign Application Priority Data
Jul. 20, 2023 (JP) 2023-118459

(51) Int. Cl. G06F 3/06; G06F 11/14

(52) U.S. Cl. CPC G06F 3/0619; G06F 3/065; G06F 3/0689; G06F 11/1461; G06F 2201/84

(57) ABSTRACT

A storage system and a backup method for the storage system capable of reliably periodically backing up data of the storage system without being affected by a load of a network are proposed. When receiving, from a storage management server, a setting of periodic backup including at least a backup frequency for data of the storage system, a scheduler sets a schedule including a time-point for the periodic backup. A backup unit periodically creates backup data according to the time-point in the schedule set by the scheduler. A data transfer unit transfers the created backup data to a cloud storage device according to the time-point in the schedule set by the scheduler.

### CROSS-REFERENCE TO RELATED APPLICATION

The present application claims priority from Japanese application JP2023-118459, filed on Jul. 20, 2023, the content of which is hereby incorporated by reference into this application.

### BACKGROUND OF THE INVENTION

### 1. Field of the Invention

The present invention relates to a storage system and a backup method for the storage system, and is suitably applied to, for example, a storage system capable of periodically backing up data of the storage system.

### 2. Description of Related Art

In recent years, in the storage market, the use of a so-called hybrid cloud storage system in which an on-premise storage system owned by a customer and a cloud storage service on a cloud system are used in cooperation with each other has increased.

In a cloud system, a storage management service is provided by a storage management server that manages an on-premise storage system. In the storage management service, setting and monitoring of a storage system, and operation of backup and snapshots are performed.

As a backup technique for a storage system, there is a backup method disclosed in PTL 1. PTL 1 discloses a method of backing up data of a storage system to a cloud storage service. In the backup method disclosed in PTL 1, a storage management service on a cloud system has a backup scheduler, and when a storage system receives an instruction for backup or the like from the backup scheduler, the storage system periodically backs up data of the storage system in accordance with the instruction.

### CITATION LIST

### Patent Literature

PTL 1: U.S. Pat. No. 9,501,365B2

### SUMMARY OF THE INVENTION

However, in the backup method disclosed in PTL 1, when an instruction for backup or the like from the backup scheduler of the storage management service on the cloud is sent over a wide area network (WAN), the instruction for backup or the like may reach or may not reach an on-premise storage system depending on a network condition of the WAN, which is unstable. This means that the backup can or cannot be performed, and reliable data protection by periodical backup cannot be implemented.

The invention has been made in view of the above points, and it is an object of the invention to provide a storage system and a backup method for the storage system capable of reliably periodically backing up data of the storage system without being affected by a load of a network.

In order to solve such problems, the invention provides a storage system including a processor and a storage device and holding data to be backed up, the storage system being connected, via a network, to a storage management server and a cloud storage device capable of storing backup data obtained by backup, the storage system including: a scheduler configured to, when receiving a setting of periodic backup including at least a backup frequency for the data of the storage system from the storage management server, set a schedule including a time-point for the periodic backup; a backup unit configured to periodically create backup data according to the time-point in the schedule set by the scheduler; and a data transfer unit configured to transfer the created backup data to the cloud storage device according to the time-point in the schedule set by the scheduler.

Further, the invention provides a backup method for a storage system including a processor and a storage device and holding data to be backed up, the storage system being connected, via a network, to a storage management server and a cloud storage device capable of storing backup data obtained by backup, the backup method including: a schedule setting step of a scheduler, when receiving a setting of periodic backup including at least a backup frequency for the data of the storage system from the storage management server, setting a schedule including a time-point for the periodic backup; a backup step of a backup unit periodically creating backup data according to the time-point in the schedule set by the scheduler; and a data transfer step of a data transfer unit transferring the created backup data to the cloud storage device according to the time-point in the schedule set by the scheduler.

According to the storage system and the backup method for the storage system of the invention, since the storage system does not need to receive instructions for backup or the like one by one via the network between the storage management server on the cloud system and the storage system, it is possible to reliably periodically back up the data of the storage system without being affected by the load of the network between the storage management server on the cloud system and the storage system.

According to the invention, it is possible to provide a storage system and a backup method for the storage system capable of reliably periodically backing up data of the storage system without being affected by a load of a network.

### BRIEF DESCRIPTION OF THE DRAWINGS

FIG. 1 is a block diagram conceptually illustrating a configuration example of a cloud storage system according to a first embodiment;

FIG. 2 is a block diagram illustrating a system configuration example of a cloud system;

FIG. 3 is a block diagram illustrating a system configuration example of a storage management unit;

FIG. 4 is a block diagram illustrating a system configuration example of a SmartNIC;

FIG. 5 is a diagram illustrating an example of an information sharing table;

FIG. 6 is a diagram illustrating an example of a backup setting screen;

FIG. 7 is a flowchart illustrating an example of a procedure of backup schedule setting processing;

FIG. 8 is a flowchart illustrating an example of a procedure of cloud backup processing;

FIG. 9 is a flowchart illustrating an example of a procedure of snapshot acquisition processing;

FIG. 10 is a flowchart illustrating an example of a procedure of data transfer processing;

FIG. 11 is a block diagram conceptually illustrating a configuration example of a cloud storage system according to a second embodiment;

FIG. 12 is a flowchart illustrating an example of a procedure of backup schedule setting processing according to the second embodiment;

FIG. 13 is a flowchart illustrating an example of a procedure of cloud backup processing according to the second embodiment;

FIG. 14 is a block diagram conceptually illustrating a configuration example of a cloud storage system according to a third embodiment;

FIG. 15 is a flowchart illustrating an example of a procedure of backup schedule setting processing according to the third embodiment; and

FIG. 16 is an example of a flowchart of cloud backup processing according to the third embodiment.

### DESCRIPTION OF EMBODIMENTS

Hereinafter, an embodiment of the invention will be described in detail with reference to the drawings.

### First Embodiment

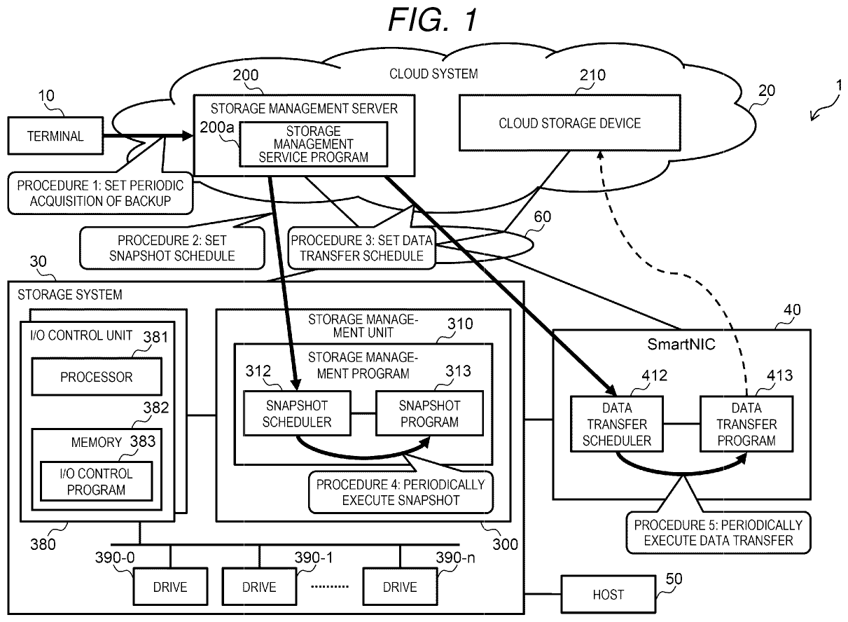

FIG. 1 is a block diagram conceptually illustrating a configuration example of a hybrid cloud storage system (hereinafter, referred to as a “cloud storage system”) 1 according to a first embodiment.

The cloud storage system 1 includes a terminal 10, a cloud system 20, a storage system 30, a SmartNIC 40, a plurality of hosts 50, and a network 60. The network 60 is a network such a as wide area network (WAN), and a communication speed thereof may vary according to a load of the network. The network 60 connects the storage system 30, which includes a processor and a storage device and holds data to be backed up, to the cloud system 20, and also connects the SmartNIC 40. The SmartNIC 40 is separate from the storage system 30 in the illustrated example, and may be integrated with the storage system 30. In the embodiment, the example in which the SmartNIC 40 is separate from the storage system 30 will be described.

The terminal 10 and the cloud system 20 are connected by a network such as an in-base local area network (LAN) or a wide area network (WAN). The cloud system 20 includes a storage management server 200 and a cloud storage device 210.

The storage management server 200 includes a storage management service program 200a, and uses the storage management service program 200a to provide a storage management service related to backup control of data of the storage system 30. The cloud system 20 provides a cloud storage service of the cloud storage device 210 capable of storing backup data based on backup of data of the storage system 30 using the cloud storage device 210.

The storage system 30 is, for example, a disk array device that provides a data protection function based on redundant array of independent (or inexpensive) disks (RAID), a data copy function inside and outside the storage system 30, and the like.

The storage system 30 includes a storage management unit 300, a plurality of redundant I/O control units 380, and a plurality of drives 390 (390-0, 390-1, . . . , 390-n), and provides block access to the host 50. The drive 390 is a physical storage device such as a solid state drive (SSD) or a hard disk drive (HDD). The storage system 30 and the host 50 are connected using a protocol such as FC or iSCSI.

The I/O control unit 380 includes a processor 381 and a memory 382. The processor 381 executes various types of processing in accordance with programs stored in the memory 382. The memory 382 is, for example, a random access memory (RAM) and stores programs to be executed by the processor 381 and necessary information. The memory 382 stores an I/O control program 383.

The I/O control unit 380 configures one or more logical volumes based on a storage area of the connected drive 390 according to the I/O control program 383, and provides the configured one or more logical volumes to the host 50. According to the I/O control program 383, the I/O control unit 380 issues a read/write I/O to the drive 390 based on a read/write I/O from the host 50 and executes I/O processing.

The storage management unit 300 executes processing for performing various settings and monitoring of the storage system 30. The storage management unit 300 includes a storage management program 310. The storage management program 310 includes a snapshot scheduler 312 and a snapshot program 313.

The SmartNIC 40 includes a processor (not shown), a data transfer scheduler 412, and a data transfer program 413. The data transfer scheduler 412 and the data transfer program 413 run on the processor of the SmartNIC 40.

Describing an outline of backup of the cloud storage system 1, when a setting of a backup schedule is received, the storage management service program 200a of the storage management server 200 on the cloud system 20 sets a snapshot schedule for the snapshot scheduler 312 of the storage management program 310 on the storage system 30, and sets a data transfer schedule for the data transfer scheduler 412 on the SmartNIC 40. Then, the snapshot scheduler 312 periodically acquires a snapshot according to the setting. Further, the data transfer scheduler 412 periodically performs data transfer to the cloud storage device 210 according to the setting. Accordingly, the cloud backup is implemented.

More specifically, the cloud storage system 1 includes: the snapshot scheduler 312 as an example of a scheduler that sets a schedule including a time-point for periodic backup when receiving, from the storage management server 200, a setting of the periodic backup including at least a backup frequency for the data of the storage system 30, specifically, for example, when receiving a first setting indicating execution of the periodic backup and a second setting of the periodic backup including at least a backup frequency; the snapshot program 313 as an example of a backup unit that periodically creates backup data by periodically acquiring a snapshot for the data of the storage system according to the time-point in the schedule set by the snapshot scheduler 312; and the data transfer program 413 as an example of a data transfer unit that transfers the created backup data to the cloud storage device 210 according to the time-point in the schedule set by the snapshot scheduler 312.

Here, the scheduler according to the first embodiment includes the snapshot scheduler 312 that runs on the processor of the storage system 30 and instructs the snapshot program 313 based on a time-point in an execution schedule of the snapshot program 313, and the data transfer scheduler 412 that runs on the processor of the SmartNIC 40 and instructs the data transfer program 413 based on a time-point in a transfer schedule of the backup data to be transferred by the data transfer program 413 serving as an example of the data transfer unit.

First, a system administrator operates the terminal 10 to access the storage management server 200 of the cloud system 20. In the storage management server 200, the storage management service program 200a receives an operation from the terminal 10 and causes the terminal 10 to display a backup setting screen described later. The system administrator performs input necessary for executing periodic backup on the backup setting screen, and the terminal 10 sets, in the storage management server 200, information on the periodic backup set according to the input content (corresponding to a “procedure 1” in the drawing).

In the storage management server 200 that receives the setting of the periodic backup, the storage management service program 200a sets the snapshot schedule for the snapshot scheduler 312 of the storage system 30 via the network 60 (corresponding to a “procedure 2” in the drawing).

In addition, the storage management server 200 sets the data transfer schedule for the data transfer scheduler 412 of the SmartNIC 40 via the network 60 (corresponding to a “procedure 3” in the drawing).

The snapshot scheduler 312 periodically executes the snapshot program 313 according to time-points in the set snapshot schedule and acquires snapshots (corresponding to a “procedure 4” in the drawing).

The data transfer scheduler 412 periodically executes the data transfer program 413 according to time-points in the set data transfer schedule, and transfers data of the snapshots acquired by the snapshot program 313 to the cloud storage device 210 (corresponding to a “procedure 5” in the drawing).

In the storage management server 200, the storage management service program 200a sets the schedules relating to the periodic backup for the snapshot scheduler 312 and the data transfer scheduler 412 via the network 60 by the procedures 1 to 5 only when the system administrator sets the periodic backup. Accordingly, it is possible to implement the operation related to the execution of the periodic backup without instructing the actual periodic backup one by one via the network 60.

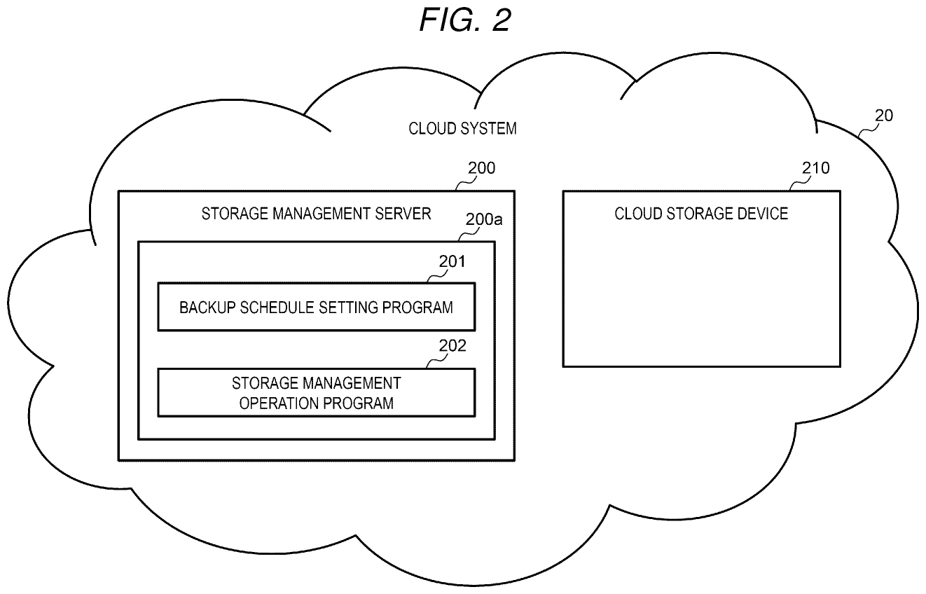

FIG. 2 is a block diagram illustrating a system configuration example of the cloud system 20 illustrated in FIG. 1. As described above, the cloud system 20 includes the storage management server 200 and the cloud storage device 210.

The storage management server 200 uses the storage management service program 200a to provide a service for performing operation management of a plurality of storage systems 30 inside and outside the cloud system 20. The storage management server 200 includes, for example, a backup schedule setting program 201 and a storage management operation program 202, as the storage management service program 200a.

The backup schedule setting program 201 is a program for setting a backup schedule of the storage system. The storage management operation program 202 is a program for operating the storage systems inside and outside the cloud system 20. The storage system 30 is operated using an application programming interface (API) for operation management provided by the storage system 30.

The cloud storage device 210 provides a cloud storage service for storing data on the cloud system 20. A data input/output interface provides objects, files, blocks, and the like.

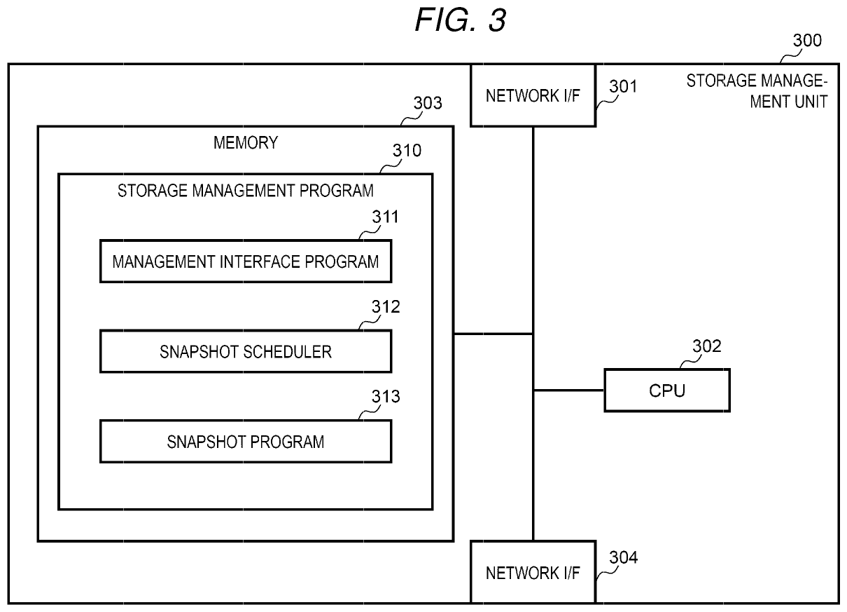

FIG. 3 is a block diagram illustrating a system configuration example of the storage management unit 300. The storage management unit 300 includes a memory 303, a CPU 302, and network I/Fs 301 and 304 as hardware, and is operated by an operating system (not illustrated). The memory 303, the CPU 302, and the network I/Fs 301 and 304 are connected to each other via a communication path such as a bus. The CPU 302 executes a program stored in the memory 303. The network I/F 301 is an interface that communicates with the cloud system 20 via the network 60. The network I/F 304 is an interface for communicating with the I/O control unit 380.

The memory 303 stores the storage management program 310. The storage management program 310 includes a management interface program 311, the snapshot scheduler 312, and the snapshot program 313. The programs and information stored in the memory 303 may be stored in a predetermined storage device instead of the memory 303. In this case, the management interface program 311, the snapshot scheduler 312, and the snapshot program 313 are read from the predetermined storage device into the memory 303 and executed by the CPU 302.

The management interface program 311 is a program that provides an API for operating the storage system 30 and receives an operation via the network 60. The snapshot scheduler 312 is a program that receives a snapshot schedule and manages the snapshot schedule. The snapshot program 313 is a program for cooperating with the I/O control unit 380 and acquiring and deleting a snapshot of a volume. The snapshot program 313 has a function of periodically acquiring, as backup data, a snapshot of the data of the storage system 30 when a schedule for the periodic backup is set by the snapshot scheduler 312 serving as an example of the scheduler.

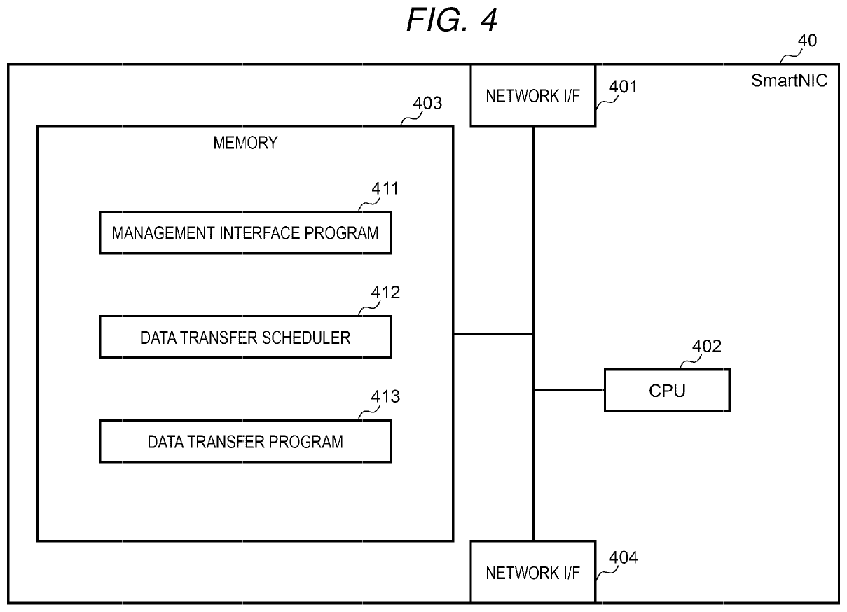

FIG. 4 is a block diagram illustrating a system configuration example of the SmartNIC 40. The smartNIC 40 is an example of a network interface device, and includes a memory 403, a CPU 402, and network I/Fs 401 and 404, and is operated by an operating system (not illustrated). The memory 403, the CPU 402, and the network I/Fs 401 and 404 are connected to each other via a communication path such as a bus. The CPU 402 executes a program stored in the memory 403.

The network I/F 401 is an interface for communicating with the cloud system 20 via the network 60. The network I/F 404 is an interface for communicating with the storage management unit 300.

The memory 403 includes a management interface program 411, the data transfer scheduler 412, and the data transfer program 413. The programs and information stored in the memory 403 may be stored in a storage device. In this case, the programs and information are read into the memory 403 and executed by the CPU 402.

The management interface program 411 is a program that provides an API for operating management of data transfer and receives an operation from the network 60. The data transfer scheduler 412 is a program that receives a data transfer schedule and manages the data transfer schedule. The data transfer program 413 is a program that runs on the processor of the SmartNIC 40, and communicates with the cloud storage device 210 of the cloud system 20 to write and read data.

In FIG. 4, the configuration of the SmartNIC is illustrated as an example of a network interface card, and the configuration of the network interface card is not limited to the SmartNIC, and a physical server, a virtual server, a container, or the like may substitute the SmartNIC.

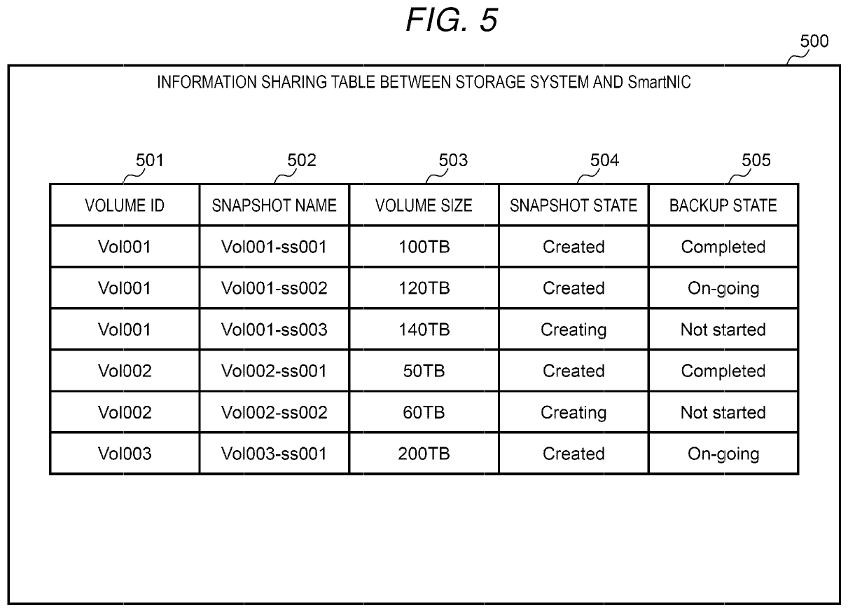

FIG. 5 illustrates an example of an information sharing table 500 between the storage system 30 and the SmartNIC 40. The information sharing table 500 is a table for sharing backup data information between the snapshot program 313 and the data transfer program 413. The information sharing table 500 may be managed as a volume by the storage management unit 300 of the storage system 30, and can be referred to from the SmartNIC 40 as appropriate.

The information sharing table 500 manages a volume ID 501, a snapshot name 502, a volume size 503, a snapshot state 504, and a backup state 505. The volume ID 501 indicates an ID for identifying a volume. The snapshot name 502 indicates a name for identifying a snapshot for the volume ID 501.

The volume size 503 indicates a volume size of the snapshot. The snapshot state 504 indicates a state of the snapshot. The state of the snapshot includes “Created” and “Creating”. The state of the snapshot may further include “Deleted”, “Deleting”, “Failed”, and “Cancelled”.

The backup state 505 indicates a state of backup. The backup state 505 includes “Completed”, “On-going”, and “Not started”. The backup state 505 may include “Failed” and “Cancelled”.

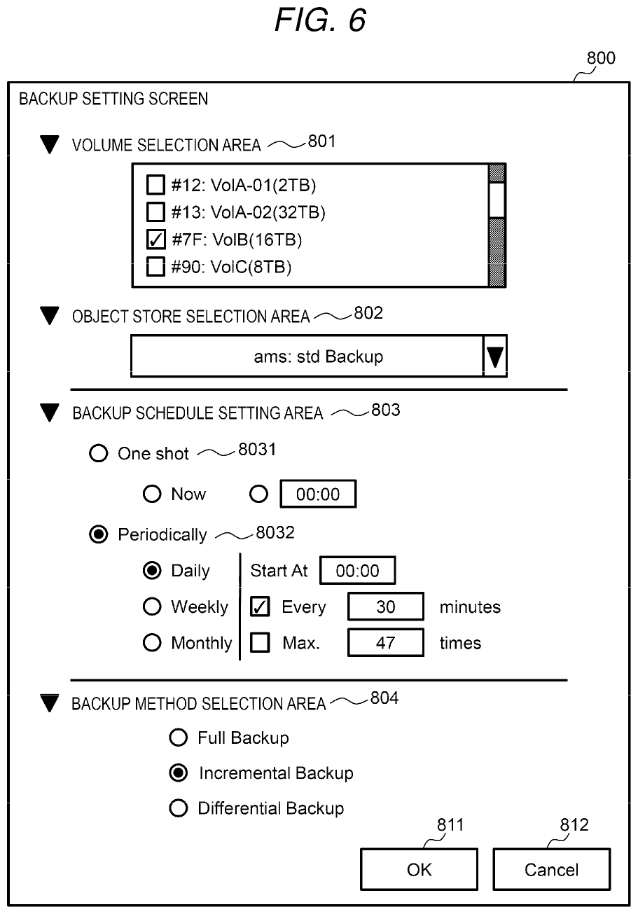

FIG. 6 illustrates an example of a backup setting screen 800. The backup setting screen 800 is displayed on the terminal 10 or the like based on data provided to the terminal 10 or the like by the storage management service program 200a of the storage management server 200 on the cloud system 20.

The backup setting screen 800 includes a logical volume selection area 801, an object store selection area 802, a backup schedule setting area 803, and a backup method selection area 804.

The logical volume selection area 801 is an area for selecting a logical volume to be backed up. In the illustrated example, in the logical volume selection area 801, a logical volume of VolB (16 TB) indicated by a volume number (corresponding to “#” in the drawing) “7F” is selected as an object to be backed up.

The object store selection area 802 is implemented by, for example, a drop down box. The object store selection area 802 is an area for selecting an object store to be a backup destination of the logical volume. In the object store selection area 802, an already registered object store as a storage destination of backup data is selectably displayed. In the illustrated example, an object store corresponding to “ams: std Backup”, that is, a backup type called “standard backup (std Backup)” of the cloud system 20 named “ams” is selected.

The backup schedule setting area 803 is an area for setting a backup schedule. In the backup schedule setting area 803, for example, a One Shot designation button (corresponding to “One Shot” in the drawing) 8031 for setting execution of only one time of backup and a Periodically designation button 8032 for setting execution of periodic backup are displayed.

When the One shot designation button 8031 is selected, it is possible to execute the backup immediately or to designate an execution start time-point by input of the system administrator. In addition, when the Periodically designation button 8032 is selected, a repetition interval (for example, on a daily basis, on a weekly basis, and on a monthly basis), an execution start time-point, the execution interval time-point, the number of executions, and the like can be designated. In the illustrated example, periodic backup execution is selected as the backup schedule, and it is specified that the backup is executed daily at intervals of 30 minutes from 0:00.

The backup method selection area 804 is an area for setting a backup method. In the illustrated example, selectable backup methods include Full Backup for backing up all logical volumes, Incremental Backup for backing up only the difference in the logical volume from the previous backup, and Differential Backup for backing up the difference in the logical volume from the previous full backup. In the illustrated example, the Incremental Backup is designated.

An OK button 811 is a button for receiving an instruction to register the backup schedule set on the backup setting screen 800. When the OK button 811 is pressed, the set backup schedule is passed to backup schedule setting processing executed by the backup schedule setting program 201.

A cancel button 812 is a button for receiving an instruction to discard the backup schedule set on the backup setting screen 800. When the cancel button 812 is pressed, the backup schedule set on the backup setting screen 800 is canceled.

Here, a plurality of backup schedules may be created for one logical volume. For example, a schedule of performing full backup, at 0:00 of every Sunday, on the logical volume to be backed up and a schedule of performing the incremental backup, at 0:00 of Monday to Saturday, on the logical volume to be backed up may be created, and in this case, the backup of the logical volume is performed with a combined schedule thereof.

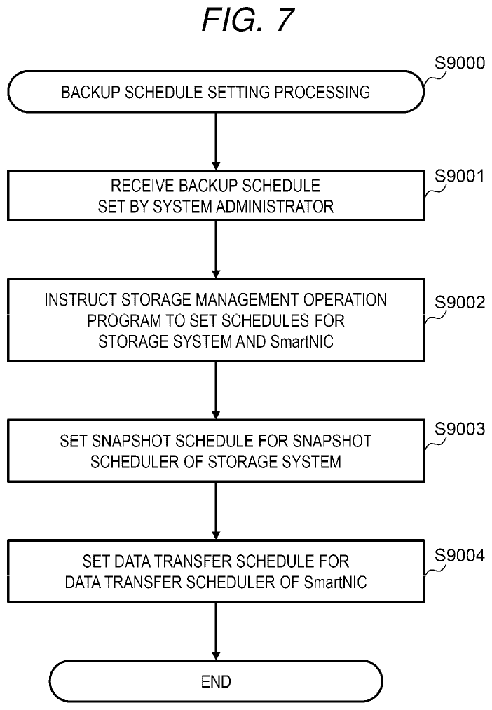

FIG. 7 is a flowchart illustrating an example of a procedure of backup schedule setting processing S9000. The backup schedule setting processing S9000 is executed by the backup schedule setting program 201 of the storage management service on the cloud system 20.

The backup schedule setting processing S9000 is performed when the system administrator sets the backup schedule from the backup setting screen 800 displayed on the terminal 10 or the like. The backup schedule setting program 201 receives schedule set by the system the backup administrator on the backup setting screen 800 of the terminal 10 or the like (step S9001).

The backup schedule setting program 201 instructs the storage management operation program 202 to set schedules for the storage system 30 and the SmartNIC 40 (step S9002).

The storage management operation program 202 sets a snapshot schedule for the snapshot scheduler 312 of the storage system 30 (step S9003). The storage management operation program 202 sets a data transfer schedule for the data transfer scheduler 412 of the SmartNIC 40 (step S9004), and ends the backup schedule setting processing.

By the backup schedule setting processing 9000, a periodic schedule is set for the snapshot scheduler 312 of the storage system 30 and the data transfer scheduler 412 of the SmartNIC 40, and the backup operation is enabled.

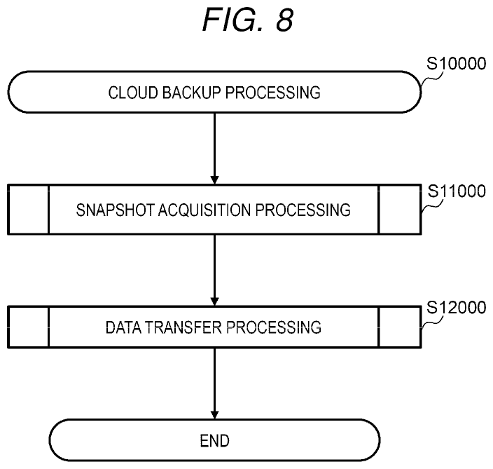

FIG. 8 is a flowchart illustrating an example of a procedure of cloud backup processing S10000. The cloud backup processing S10000 is periodically executed by the storage system 30 and the SmartNIC 40 in cooperation with each other.

Although snapshot acquisition processing S10001 is executed first, the snapshot acquisition processing S10001 will be described later. Although data transfer processing S12000 is executed thereafter, the data transfer processing S12000 will be described later.

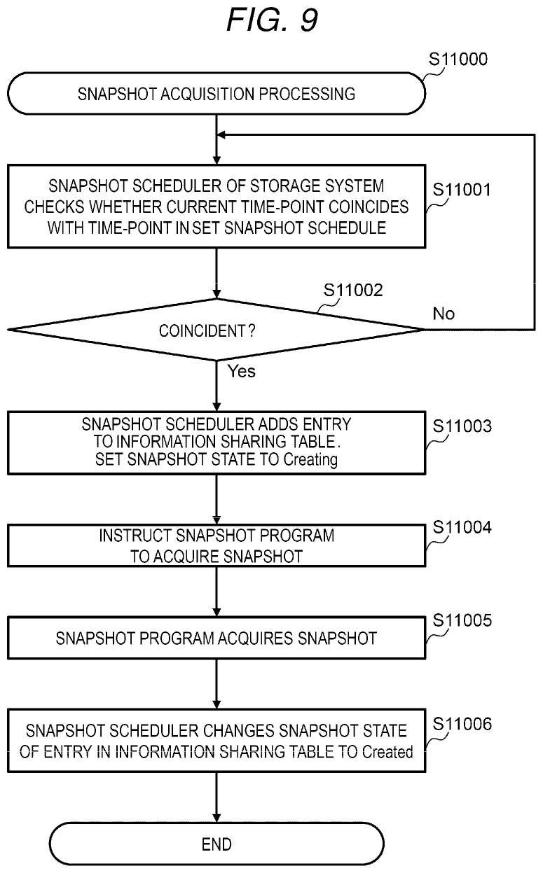

FIG. 9 is a flowchart illustrating an example of a procedure of the snapshot acquisition processing S11000 illustrated in FIG. 8. The snapshot acquisition processing S11000 is periodically executed according to the snapshot schedule set for the snapshot scheduler 312.

The snapshot scheduler 312 of the storage system 30 checks whether the current time-point coincides with a time-point in the set snapshot schedule (step S11001). When the current time-point does not coincide with the time-point in the set snapshot schedule (step S11002: No), the snapshot scheduler 312 executes step S11001 again.

On the other hand, when the current time-point coincides with the time-point in the set snapshot schedule (step S11002: Yes), the snapshot scheduler 312 adds an entry to the information sharing table 500. At this time, the snapshot state is set to “Creating” (step S11003). The snapshot scheduler 312 instructs the snapshot program 313 to acquire a snapshot (step S11004).

The snapshot program 313 acquires a snapshot (step S11005) and returns a response to the snapshot scheduler 312.

The snapshot scheduler 312 receives the response from the snapshot program 313, changes the snapshot state of the entry in the information sharing table 500 to “Created” (step S11006), and ends the snapshot acquisition processing S11000.

As described above, in the snapshot acquisition processing S11000 illustrated in FIG. 9, an example is illustrated in which the snapshot scheduler 312 adds an entry to the information sharing table 500 and changes the setting of the snapshot state. Alternatively, the snapshot program 313 may add the entry and change the setting of the snapshot state.

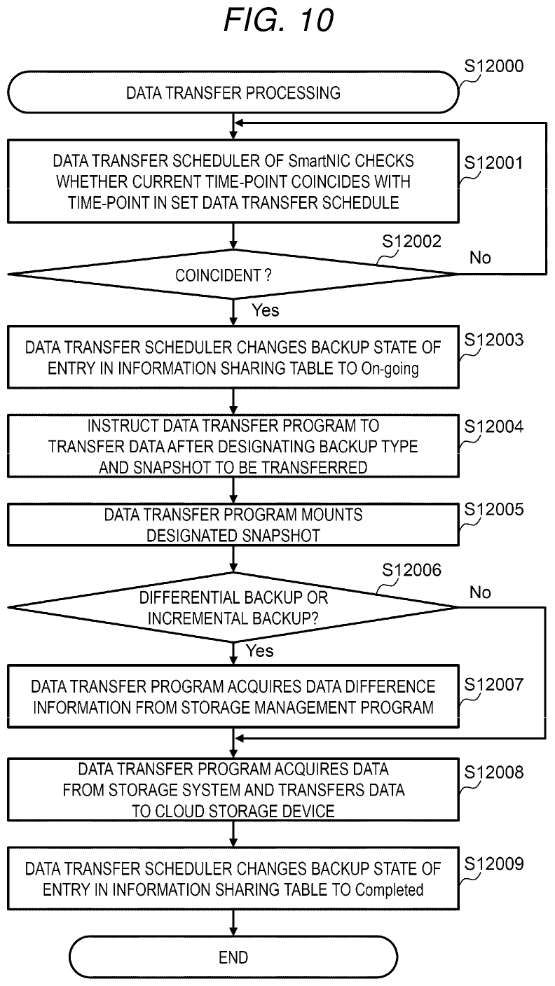

FIG. 10 is a flowchart illustrating an example of a procedure of the data transfer processing S12000. The data transfer processing S12000 is periodically executed according to time-points in the data transfer schedule set for the data transfer scheduler 412.

The data transfer scheduler 412 of the SmartNIC 40 checks whether the current time-point coincides with a time-point in the set data transfer schedule (step S12001). When the current time-point does not coincide with the time-point in the set data transfer schedule (step S21002: NO), the data transfer scheduler 412 executes step S12001 again.

On the other hand, when the current time-point and the time-point in the set data transfer schedule coincide with each other (step S12002: Yes), the data transfer scheduler 412 changes the backup state of the entry in the information sharing table 500 to “On-going” (step S12003).

The data transfer scheduler 412 instructs the data transfer program 413 to transfer data after designating the backup type and the snapshot to be transferred (step S12004). The backup type is any of the full backup, the differential backup, and the incremental backup. The data transfer program 413 mounts the snapshot designated by the data transfer scheduler 412 (step S12005). The mounting here means connecting a snapshot to a logical volume to be acquired.

The data transfer program 413 checks the backup type designated by the data transfer scheduler 412, and if the backup type is the differential backup or the incremental backup (step S12006: Yes), executes step S12007, while if the backup type is neither the differential backup nor the incremental backup (step S12006: No), that is, if the backup type is the full backup, executes step S12008.

The data transfer program 413 acquires data difference information from the storage management program 310 (step S12007). The data difference information is a data difference between snapshots, and includes information on a block that is updated between a previous snapshot and a current snapshot. The data difference information may be acquired from the information sharing table 500 or may be acquired by another method. For example, the data transfer program 413 may instruct the storage management program 310 of the storage system 30 via a management network.

The data transfer program 413 acquires data from the storage system 30, transfers the data to the cloud storage device 210, and returns a response to the data transfer scheduler 412 when the data transfer is completed (step S12008).

When receiving the response from the data transfer program 413, the data transfer scheduler 412 changes the backup state of the entry in the information sharing table 500 to “Completed” (step S12009), and ends the data transfer processing S12000.

As described above, in the data transfer processing S12000 illustrated in FIG. 10, an example is illustrated in which the data transfer scheduler 412 changes the setting of the backup state of the entry of the information sharing table 500. Alternatively, the data transfer program 413 may change the setting of the backup state.

As described above, according to the first embodiment, the storage system 30 including the processor 381 and the storage device and holding data to be backed up is connected, via the network 60, to the storage management server 200 and the cloud storage device 210 capable of storing backup data obtained by backup. The storage system 30 includes: the snapshot scheduler 312 as an example of a scheduler that sets a schedule including a time-point for periodic backup when receiving, from the storage management server 200, a setting of the periodic backup including at least a backup frequency for the data of the storage system 30; the snapshot program 313 as an example of a backup unit that periodically creates backup data according to the time-point in the schedule set by the snapshot scheduler 312; and the data transfer program 413 as an example of a data transfer unit that transfers the created backup data to the cloud storage device 210 according to the time-point in the schedule set by the snapshot scheduler 312.

In this way, since the storage system 30 does not need to receive instructions for backup or the like one by one via the network 60 when performing periodic backup, it is possible to reliably periodically back up the data of the storage system 30 without being affected by the load of the network 60 between the storage management server 200 on the cloud system 20 and the storage system 30.

Further, in the first embodiment, when the schedule is set by the snapshot scheduler 312, the snapshot program 313 periodically acquires snapshots of the data of the storage system 30. In this way, the snapshot program 313 can periodically acquire snapshots of the data of the storage system 30 and perform periodic backup without delay due to the load of the network 60.

In the first embodiment, the snapshot scheduler 312 and the snapshot program 313 are provided in the storage system 30. In this way, it is not necessary for the snapshot scheduler 312 and the snapshot program 313 to exchange with each other via the network, and the snapshot program 313 can acquire a snapshot without delay according to the time-point in the schedule set by the snapshot scheduler 312.

In the first embodiment, the scheduler includes the snapshot scheduler 312 that sets a periodic execution schedule of the snapshot program 313 when receiving the second setting from the storage management server 200, and the data transfer scheduler 412 that sets a transfer schedule of backup data to be transferred by the data transfer program 413 when receiving the second setting from the storage management server 200. In this way, since the storage system 30 does not need to receive instructions for backup or the like one by one via the network 60 between the storage management server 200 on the cloud system 20 and the storage system 30, it is possible to reliably periodically back up the data of the storage system 30 without being affected by the load of the network 60 between the storage management server 200 on the cloud system 20 and the storage system 30.

In the first embodiment, the information sharing table 500 for sharing a state of the periodic backup between the storage system 30 and the SmartNIC 40 is also provided. In this way, it is possible to periodically back up the data of the storage system 30 without delay while the storage system 30 and the SmartNIC 40 cooperate with each other.

Further, in the first embodiment, the data transfer program 413 is provided in the SmartNIC 40 that is a configuration independent of the storage system 30. The data transfer program 413 runs on the processor of the SmartNIC 40. In this way, the data transfer program 413 can transfer backup data obtained by periodic backup to the cloud storage device 210 in a timely manner without being affected by the load of the storage system 30.

### Second Embodiment

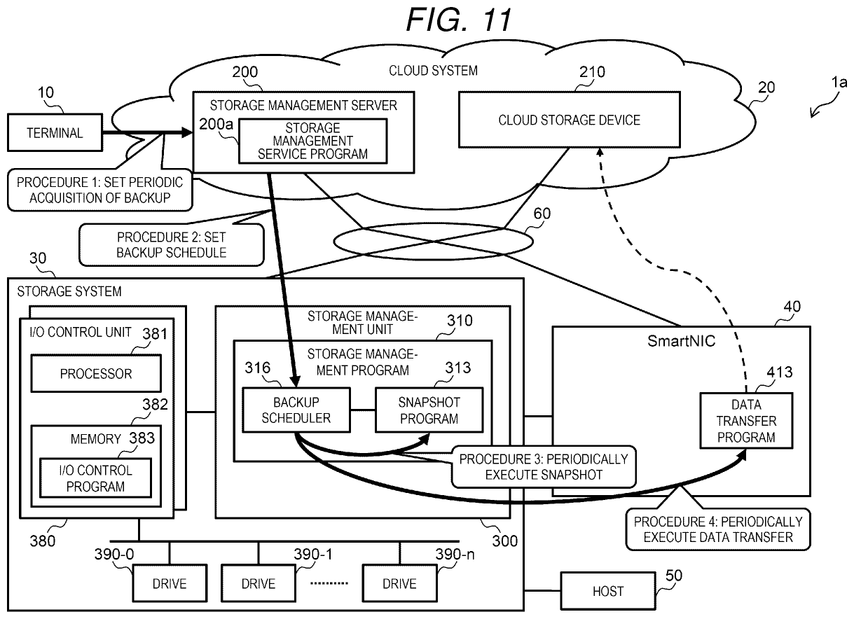

In a second embodiment, descriptions of configurations and processing similar to those of the first embodiment will be omitted, and differences from the first embodiment will be mainly described. FIG. 11 is a block diagram conceptually illustrating a configuration example of a cloud storage system 1a according to the second embodiment.

The second embodiment is different from the first embodiment in that the storage management unit 300 includes a backup scheduler 316 instead of the snapshot scheduler 312 and the SmartNIC 40 does not include the data transfer scheduler 412. That is, in the second embodiment, the backup scheduler 316 of the storage management unit 300 has the function of the snapshot scheduler 312 according to the first embodiment, and also has the function of the data transfer scheduler 412 according to the first embodiment. Accordingly, the backup scheduler 316 and the snapshot program 313 are provided in the storage management unit 300.

In the second embodiment, when receiving a setting of a backup schedule via the backup setting screen 800, the storage management service program 200a of the storage management server 200 on the cloud system 20 sets a backup schedule for the backup scheduler 316 of the storage management program 310 on the storage system 30. Then, the backup scheduler 316 periodically acquires snapshots according to the setting, and periodically performs data transfer to the cloud storage device 210. Accordingly, the cloud backup is implemented.

A system administrator accesses the storage management server 200 of the cloud system 20 from the terminal 10. The storage management server 200 receives an operation from the terminal 10 and displays the backup setting screen 800 on the terminal 10. The system administrator inputs a setting of periodic backup on the backup setting screen 800, and the terminal 10 sets information on the set periodic backup in the storage management server 200 (corresponding to a “procedure 1” in the drawing).

The storage management server 200 that receives the setting of the periodic backup sets a backup schedule for the backup scheduler 316 of the storage system 30 via the network 60 (corresponding to a “procedure 2” in the drawing). This setting corresponds to the second setting. The backup scheduler 316 runs on the processor of the storage system 30, instructs the snapshot program 313 based on a time-point in an execution schedule of the snapshot program 313, and instructs the data transfer program 413 based on a time-point in a transfer schedule of the backup data to be transferred by the data transfer program 413. Accordingly, the backup scheduler 316 periodically executes the snapshot program 313 according to time-points in the set backup schedule to acquire snapshots (corresponding to a “procedure 3” in the drawing).

The backup scheduler 316 periodically executes the data transfer program 413 according to the time-points in the set backup schedule, and transfers data of the snapshots acquired by the snapshot program 313 to the cloud storage device 210 (corresponding to a “procedure 4” in the drawing).

Through these steps, the storage management server 200 sets a periodic schedule for the backup scheduler 316 via the network 60 only when the system administrator sets the periodic backup, and an actual backup instruction can implement the operation of the periodic backup without using the network 60.

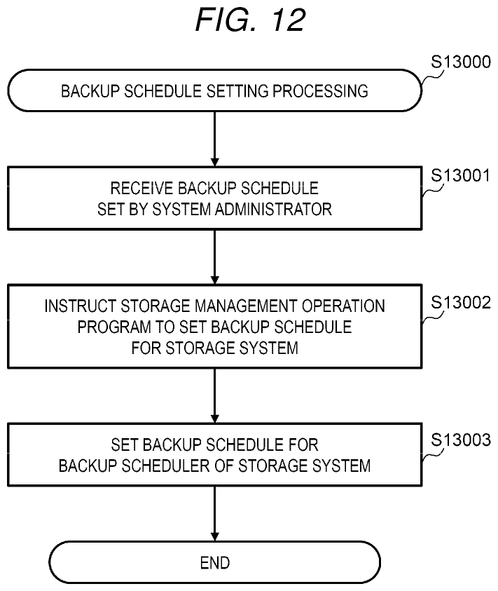

FIG. 12 is a flowchart illustrating an example of a procedure of backup schedule setting processing S13000 according to the second embodiment. The backup schedule setting processing S13000 is executed by the backup schedule setting program 201 of the storage management service program 200a of the storage management server 200 on the cloud system 20.

The backup schedule processing S13000 is performed when the system administrator sets the backup schedule from the backup setting screen 800. The backup schedule setting program 201 receives the backup schedule set by the system administrator on the backup setting screen 800 (step S13001).

The backup schedule setting program 201 instructs the storage management operation program 202 to set the backup schedule for the storage system 30 (step S13002). The storage management operation program 202 sets the backup schedule for the backup scheduler 316 of the storage system 30 (step S13003), and ends the backup schedule setting processing.

By the backup schedule setting processing S13000, a periodic schedule is set for the backup scheduler of the storage system 30, and the operation of execution of the periodic backup is enabled.

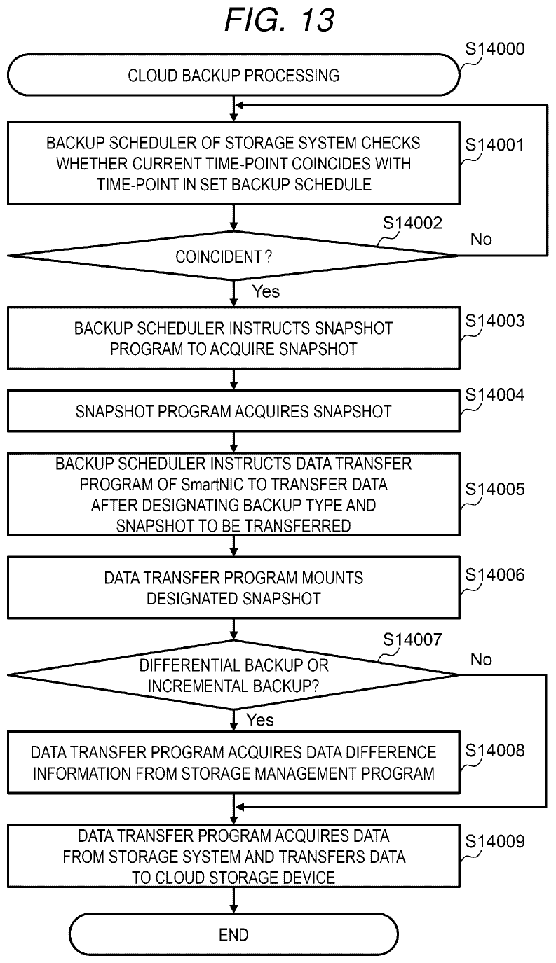

FIG. 13 is a flowchart illustrating an example of a procedure of cloud backup processing S14000 according to the second embodiment. The cloud backup processing S14000 is periodically executed by the backup scheduler 316 of the storage system 30.

The backup scheduler 316 of the storage system 30 checks whether the current time-point coincides with a time-point in the set backup schedule (step S14001). When the current time-point does not coincide with the time-point in the set backup schedule (step S14002: No), the backup scheduler 316 executes step S14001 again.

On the other hand, when the current time-point coincides with the time-point in the set backup schedule (step S14002: Yes), the backup scheduler 316 instructs the snapshot program 313 to acquire a snapshot (step S14003). The snapshot program 313 acquires a snapshot (step S14004) and returns a response to the backup scheduler 316.

The backup scheduler 316 receives the response from the snapshot program 313, and then instructs the data transfer program 413 to transfer data after designating the backup type and the snapshot to be transferred (step S14005). The backup type is any of the full backup, the differential backup, and the incremental backup.

The data transfer program 413 mounts the snapshot designated by the backup scheduler 316 (step S14006).

The data transfer program 413 checks the backup type designated by the backup scheduler 316, and if the backup type is the differential backup or the incremental backup (step S14007: Yes), executes step S14008, while if the backup type is neither the differential backup nor the incremental backup (step S14007: No), that is, if the backup type is the full backup, executes step S14009.

The data transfer program 413 acquires data difference information from the storage management program 310 (step S14008). The data difference information is a data difference between snapshots, and includes information on a block that is updated between a previous snapshot and a current snapshot. The data difference information may be acquired from the information sharing table 500 or may be acquired by another method. For example, the data transfer program 413 may instruct the storage management program 310 of the storage system 30 via a management network.

The data transfer program 413 acquires data from the storage system 30, transfers the data to the cloud storage device 210, and returns a response to the backup scheduler 316 when the data transfer is completed (step S14009).

When receiving the response from the data transfer program 413, the backup scheduler 316 ends the cloud backup processing S14000.

FIG. 13 illustrates an example in which the data transfer program 413 determines the backup type and acquires the data difference information from the storage management program 310 in the case of the differential backup or the incremental backup. Alternatively, the backup scheduler 316 may pass the data difference information to the data transfer program 413 at the timing of the backup instruction to the data transfer program 413.

In the cloud storage system 1a according to the second embodiment, the storage system 30 and the cloud system 20 are connected via the network 60, similarly to the cloud storage system 1 according to the first embodiment. The cloud storage system 1a includes: the backup scheduler 316 as an example of a scheduler that sets a schedule including a time-point for periodic backup when receiving, from the storage management server 200, a setting of the periodic backup including at least a backup frequency for the data of the storage system; the snapshot program 313 as an example of a backup unit that creates backup data according to the time-point in the schedule set by the backup scheduler 316; and the data transfer program 413 as an example of a data transfer unit that transfers the created backup data to the cloud storage device 210 according to the time-point in the schedule set by the backup scheduler 316.

In this way, since the storage system 30 does not need to receive instructions for backup or the like one by one via the network 60 between the storage management server 200 on the cloud system 20 and the storage system 30, it is possible to reliably periodically back up the data of the storage system 30 without being affected by the load of the network 60 between the storage management server 200 on the cloud system 20 and the storage system 30.

In the second embodiment, the backup scheduler 316 as an example of the scheduler and the snapshot program 313 as an example of the backup unit are provided in the storage system 30. In this way, it is not necessary for the storage management server 200 to instruct the setting of the backup to the SmartNIC 40, and it is only necessary to instruct the setting of the backup to the storage system 30. Therefore, compared to the first embodiment, it is possible to more reliably periodically perform the backup without being affected by the load of the network 60.

In the second embodiment, when receiving the setting of the periodic backup from the storage management server 200, the backup scheduler 316 as an example of the scheduler sets the periodic execution schedule of the snapshot program 313, and sets the transfer schedule of the backup data to be transferred by the data transfer program 413. In this way, it is not necessary for the storage management server 200 to instruct the setting of the backup to the SmartNIC 40, and it is only necessary to instruct the setting of the backup to the storage system 30. Therefore, compared to the first embodiment, it is possible to more reliably periodically perform the backup without being affected by the load of the network 60.

### Third Embodiment

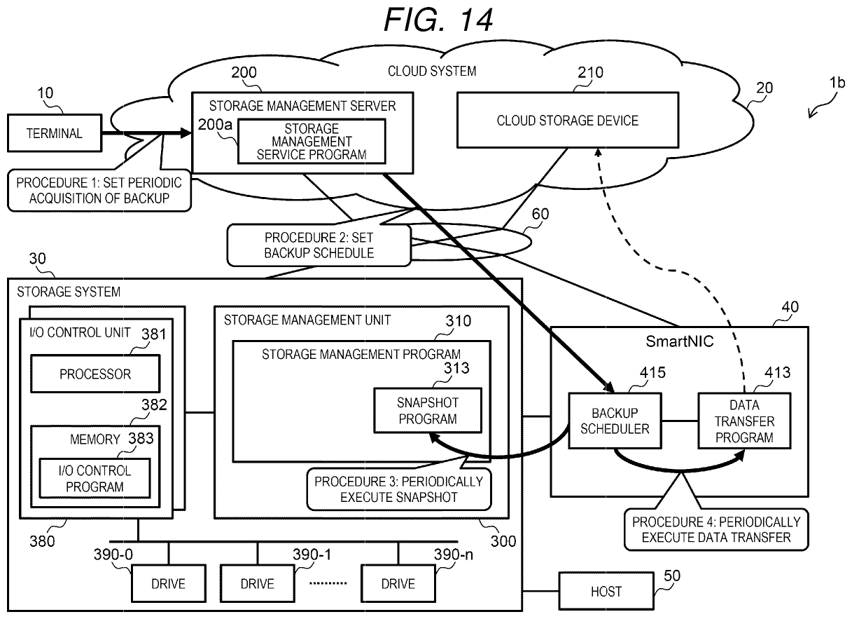

In a third embodiment, descriptions of configurations and processing similar to those of the first embodiment and the second embodiment will be omitted, and differences from the first embodiment and the second embodiment will be mainly described. FIG. 14 is a block diagram conceptually illustrating a configuration example of a cloud storage system 1b according to the third embodiment.

The third embodiment is different from the second embodiment in that the storage management unit 300 does not include the backup scheduler 316, and the SmartNIC 40 includes a backup scheduler 415 having the same function as the backup scheduler 316. Further, in the third embodiment, it can be said that the backup scheduler 415 of the SmartNIC 40 functions as the snapshot scheduler 312 of the storage management unit 300 and the data transfer scheduler 412 of the SmartNIC 40 according to the first embodiment. Alternatively, in the third embodiment, it can be said that the backup scheduler 415 of the SmartNIC 40 functions as the backup scheduler 316 of the storage management unit 300 according to the second embodiment.

In the third embodiment, when the storage management service program 200a of the storage management server 200 on the cloud system 20 receives the setting of the backup schedule via the backup setting screen 800, the storage management service program 200a sets a backup schedule for the backup scheduler 415 on the smartNIC 40. The backup scheduler 415 runs on the processor of the SmartNIC 40. The backup scheduler 415 periodically acquires snapshots according to the setting (corresponding to the second setting) by using the snapshot program 313, and periodically transfer data of the acquired snapshots to the cloud storage device 210. Accordingly, the cloud backup is implemented.

More specifically, first, system administrator accesses the storage management server 200 of the cloud system 20 from the terminal 10. The storage management server 200 receives an operation from the terminal 10 and displays the backup setting screen 800 on the terminal 10. The system administrator inputs a setting of periodic backup on the backup setting screen 800, and the terminal 10 sets information on the set periodic backup in the storage management server 200 (corresponding to a “procedure 1” in the drawing).

The storage management server 200 that receives the setting of the periodic backup sets a backup schedule for the backup scheduler 415 of the SmartNIC 40 via the network 60 (corresponding to a “procedure 2” in the drawing).

The backup scheduler 415 periodically executes the snapshot program 313 according to time-points in the set backup schedule to acquire snapshots (corresponding to “procedure 3” in the drawing).

Further, the backup scheduler 415 periodically executes the data transfer program 413 according to the time-points in the set backup schedule, and transfers data of the snapshots acquired by the snapshot program 313 to the cloud storage device 210 (corresponding to a “procedure 4” in the drawing). The data transfer program 413 runs on the processor of the SmartNIC 40.

According to the procedure 1 to the procedure 4, only when the system administrator sets the periodic backup, the storage management server 200 sets the periodic schedule for the backup scheduler 415 via the network 60, and an actual backup instruction can implement the operation of the execution of the periodic backup without using the network 60.

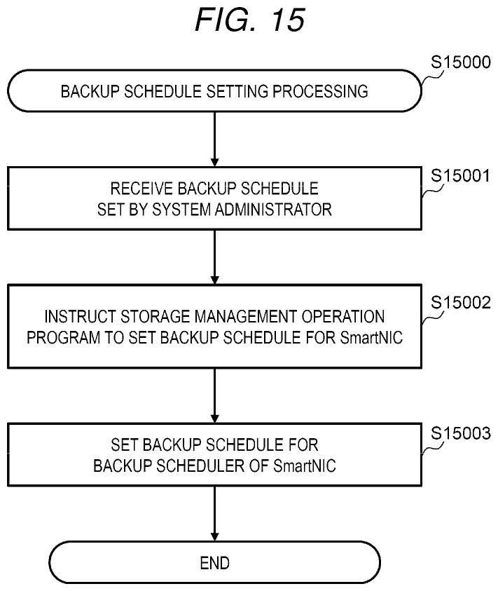

FIG. 15 is a flowchart illustrating an example of a procedure of backup schedule setting processing S15000 according to the third embodiment. The backup schedule setting processing S15000 is executed by the backup schedule setting program 201 of the storage management server 200 on the cloud system 20.

The backup schedule setting processing S15000 is performed when the system administrator sets the backup schedule from the backup setting screen 800. The backup schedule setting program 201 receives the backup schedule set by the system administrator on the backup setting screen 800 (step S15001).

The backup schedule setting program 201 instructs the storage management operation program 202 to set the backup schedule for the SmartNIC 40 (step S15002). The storage management operation program 202 sets the backup schedule for the backup scheduler 415 of the SmartNIC 40 (step S15003), and ends the backup schedule setting processing.

By the backup schedule setting processing S15000, the periodic schedule is set for the backup scheduler 415 of the SmartNIC 40, and the operation of the execution of the periodic backup is enabled.

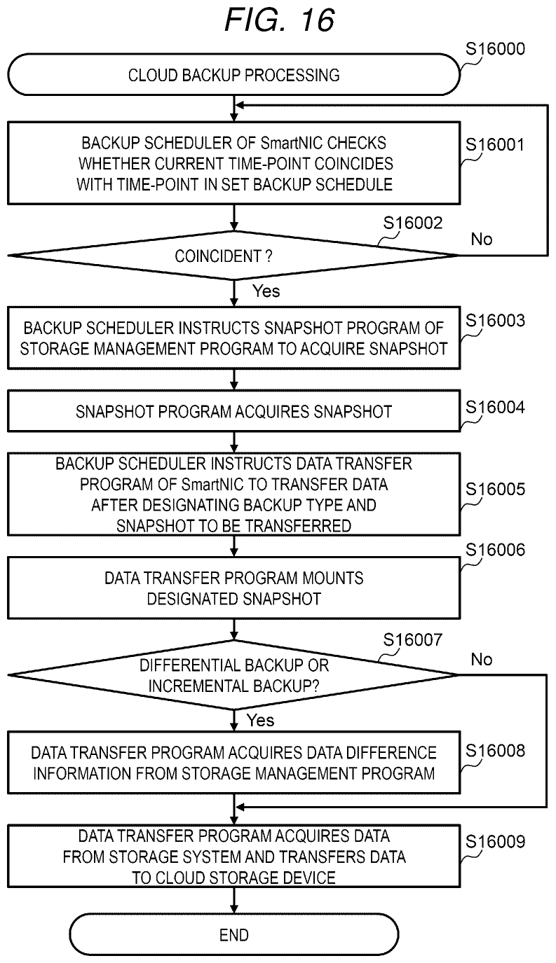

FIG. 16 is an example of a flowchart of cloud backup processing S16000 according to the third embodiment. The cloud backup processing S16000 according to the third embodiment is periodically executed by the backup scheduler 415 of the SmartNIC 40.

The backup scheduler 415 checks whether the current time-point coincides with a time-point in the set backup schedule (step S16001).

When the current time-point does not coincide with the time-point in the set backup schedule (step S16002: No), the backup scheduler 415 executes step S16001 again.

On the other hand, when the current time-point coincides with the time-point in the set backup schedule (step S16002: Yes), the backup scheduler 415 instructs the snapshot program 313 to acquire a snapshot (step S16003).

The snapshot program 313 acquires a snapshot and returns a response to the backup scheduler 415 (step S16004). The backup scheduler 415 receives the response from the snapshot program 313, and then instructs the data transfer program 413 to transfer data after designating the backup type and the snapshot to be transferred (step S16005). The backup type is any of the full backup, the differential backup, and the incremental backup.

The data transfer program 413 mounts the snapshot designated by the backup scheduler 415 (step S16006).

The data transfer program 413 checks the backup type designated by the backup scheduler 415, and if the backup type is the differential backup or the incremental backup (step S16007: Yes), executes step S16008, while if the backup type is neither the differential backup nor the incremental backup (step S16007: No), that is, if the backup type is the full backup, executes step S16009.

The data transfer program 413 acquires data difference information from the storage management program 310 (step S16008). The data difference information is a data difference between snapshots, and includes information on a block that is updated between a previous snapshot and a current snapshot. The data difference information may be acquired from the information sharing table 500 or may be acquired by another method. For example, the data transfer program 413 may instruct the storage management program 310 of the storage system 30 via a management network.

The data transfer program 413 acquires data from the storage system 30, transfers the data to the cloud storage device 210, and returns a response to the backup scheduler 415 when the data transfer is completed (step S16009).

When receiving the response from the data transfer program 413, the backup scheduler 415 ends the cloud backup processing S16000.

As described above, FIG. 16 illustrates an example in which the data transfer program 413 determines the backup type and acquires the data difference information from the storage management program 310 in the case of the differential backup or the incremental backup. Alternatively, the backup scheduler 415 may pass the data difference information to the data transfer program 413 at the timing of the backup instruction to the data transfer program 413.

In the cloud storage system 1b according to the third embodiment, the storage system 30 and the cloud system 20 are connected via the network 60, similarly to the cloud storage system 1 according to the first embodiment. The cloud storage system 1b includes: the backup scheduler 415 as an example of a scheduler that sets a schedule including a time-point for periodic backup when receiving, from the storage management server 200, a first setting indicating execution of the periodic backup for the data of the storage system 30 and a setting of the periodic backup including at least a backup frequency; the snapshot program 313 as an example of a backup unit that periodically creates backup data according to the time-point in the schedule set by the backup scheduler 415; and the data transfer program 413 as an example of a data transfer unit that transfers the created backup data to the cloud storage device 210 according to the time-point in the schedule set by the backup scheduler 415.

In this way, since the storage system 30 and the SmartNIC 40 do not need to receive instructions for backup one by one via the network 60 between the storage management server 200 on the cloud system 20 and the storage system 30, it is possible to reliably periodically back up the data of the storage system 30 without being affected by the load of the network 60 between the storage management server 200 on the cloud system 20 and the storage system 30.

In the third embodiment, when receiving the setting of the periodic backup from the storage management server 200, the backup scheduler 415 as an example of the scheduler sets the periodic execution schedule of the snapshot program 313, and sets the transfer schedule of the backup data to be transferred by the data transfer program 413. In this way, it is not necessary for the storage management server 200 to instruct the setting of the periodic backup to the storage system 30, and it is only necessary to instruct the setting of the periodic backup to the SmartNIC 40. Therefore, compared to the first embodiment, it is possible to more reliably perform the periodic backup without being affected by the load of the network 60.

In the third embodiment, the SmartNIC 40 includes the backup scheduler 415. In this way, it is not necessary for the storage management server 200 to instruct the setting of the periodic backup to the storage system 30, and it is only necessary to instruct the setting of the periodic backup to the backup scheduler 415 of the SmartNIC 40. Therefore, compared to the first embodiment, it is possible to more reliably perform the periodic backup without being affected by the load of the network 60.

### Other Embodiments

In the first to third embodiments described above, the case of backing up from the storage system 30 to the cloud storage device 210 is described, and the invention is not limited to such a use case. For example, the use case may involve a snapshot in the storage system 30. Alternatively, the use case may involve a local backup in the storage system 30. A use case in which data is restored from the cloud storage device 210 to the storage system 30 may be used.

Further, in the embodiments described above, various types of information may be described by an expression of “aaa table”, and the various types of information may be expressed by a data structure other than a table. The “aaa table” may be referred to as “aaa information” in order to indicate that the various types of information does not depend on the data structure. Further, when the description is made by using a program or software as a subject, it is considered that a processor or the like is actually executing the program or software.

In the embodiments described above, when describing the content of each piece of information, expressions such as “identifier”, “name”, and “ID” are used for the identification information, and the expressions are interchangeable with each other. Various types of identification information may be used instead of at least one of these expressions.

In the embodiments described above, although there is the case where the processing is described by using the “program” as a subject, since the program is executed by a processor to perform the determined processing using a storage resource (for example, a memory) and/or a communication interface device (for example, a communication port) as appropriate, the subject of the processing may be the processor. Conversely, the processing in which the processor is the subject can be interpreted as being performed by executing one or more programs. The processor is typically a microprocessor such as a central processing unit (CPU), and may include a hardware circuit that executes a part of processing (for example, encryption/decryption, compression/decompression).

### INDUSTRIAL APPLICABILITY

The invention can be applied to a storage system capable of executing periodic backup.

What is claimed is:

1. A storage system including a processor and a storage device and holding data to be backed up, the storage system being connected, via a network, to a storage management server and a cloud storage device capable of storing backup data obtained by backup, the storage system comprising:
a scheduler configured to, when receiving a setting of periodic backup including at least a backup frequency for the data of the storage system from the storage management server, set a schedule including a time-point for the periodic backup;
a backup unit configured to periodically create backup data according to the time-point in the schedule set by the scheduler; and
a data transfer unit configured to transfer the created backup data to the cloud storage device according to the time-point in the schedule set by the scheduler.

2. The storage system according to claim 1, wherein
the backup unit acquires, as the backup data, a snapshot of the data of the storage system by a snapshot program.

3. The storage system according to claim 1, further comprising:
a network interface including a processor, wherein
the backup unit runs on the processor of the storage system, and
the data transfer unit runs on the processor of the network interface.

4. The storage system according to claim 3, wherein
the scheduler includes
a snapshot scheduler that runs on the processor of the storage system and instructs the backup unit based on a time-point in an execution schedule of a snapshot program, and
a data transfer scheduler that runs on the processor of the network interface and sets an instruction to the data transfer unit based on a time-point in a transfer schedule of the backup data to be transferred by the data transfer unit.

5. The storage system according to claim 3, wherein
the scheduler runs on the processor of the storage system, instructs the backup unit based on a time-point in an execution schedule of a snapshot program, and instructs the data transfer unit based on a time-point in a transfer schedule of the backup data to be transferred by the data transfer unit.

6. The storage system according to claim 1, further comprising:
an information sharing table configured to share a state of the backup data between the backup unit and the data transfer unit.

7. The storage system according to claim 3, wherein
the scheduler is provided in the network interface.

8. A backup method for a storage system including a processor and a storage device and holding data to be backed up, the storage system being connected, via a network, to a storage management server and a cloud storage device capable of storing backup data obtained by backup, the backup method comprising:
a schedule setting step of a scheduler, when receiving a setting of periodic backup including at least a backup frequency for the data of the storage system from the storage management server, setting a schedule including a time-point for the periodic backup;
a backup step of a backup unit periodically creating backup data according to the time-point in the schedule set by the scheduler; and
a data transfer step of a data transfer unit transferring the created backup data to the cloud storage device according to the time-point in the schedule set by the scheduler.
